(19) United States
(12) Patent Application Publication
(10) Pub. No.: US 2003/0202108 A1
(43) Pub. Date: Oct. 30, 2003

(54) Image pick-up apparatus

(75) Inventor: Toshihisa Maeda, Sakai-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/417,955

(22) Filed: Apr. 17, 2003

(30) Foreign Application Priority Data
Apr. 24, 2002 (JP) 2002-122224

(51) Int. Cl. H04N 9/68

(52) U.S. Cl. 348/216.1; 348/234

(57) ABSTRACT

When the brightness of an object is low, a sum output mode is set in causing a CCD to output pixel values accumulated therein. When the sum output mode is set, the CCD outputs the pixel values by adding up each odd number of pixel values distributed consecutively in a specified direction. As a result, a large signal component from which color information has not been lost completely can be obtained without increasing a noise component when the brightness is low. By reproducing the color information based on pixel sum values each obtained by adding up an odd number of pixel values in an overall controller, a proper color image can be obtained even if the brightness of the object is low.

This application is based on application No. 2002-122224 filed in Japan, the content of which is hereby incorporated by reference.

### BACKGROUND OF THE INVENTION

1. Field of the Invention

The present invention relates to an image pick-up apparatus comprising a photoelectric conversion element, e.g., a digital camera or the like.

2. Description of the Related Art

In the case of taking a photograph of an object in dark environments by means of an image pick-up apparatus using a CCD image pick-up element as a photoelectric conversion element, such as a digital camera, the output values from individual pixels in the CCD image pick-up element are amplified by an automatic gain control circuit or the like. If gain used therein is set to an infinitely large value, however, even a noise component is amplified thereby so that the resulting image is significantly degraded in quality. This makes it difficult to perform a proper and precise process for each of white balance adjustment, exposure control, and automatic focus control.

To suppress image quality degradation caused by noise, there can be considered the addition of the respective output values of adjacent pixels. This is because, by adding up the output values of the adjacent pixels, a large signal component can be obtained.

In an image-pickup apparatus such as a digital camera, however, a CCD image pick-up element using the Bayer arrangement filter or the like is adopted normally so that two pixels adjacent to each other detect different color components. If the values of the adjacent pixels are added up to suppress image quality degradation caused by noise as described above, the problem is encountered that color information is lost. In this case also, accurate color adjustment and exposure control cannot be performed. If the image pick-up apparatus is provided with a display element for displaying a color image, the problem is also encountered that the color display of an image cannot be performed.

### SUMMARY OF THE INVENTION

The present invention has been achieved in view of the foregoing problems and it is therefore an object of the present invention to provide an image pick-up apparatus capable of excellently suppressing a noise component without losing color information even in dark environments.

To attain the object, an image pick-up apparatus in one aspect of the present invention comprises: a photoelectric conversion element having pixels for a first color component and pixels for a second color component which are arranged alternately in a specified direction, the photoelectric conversion element successively outputting respective values of the pixels in the specified direction; and a controller for causing, when the respective values of the pixels are outputted from the photoelectric conversion element, the photoelectric conversion element to successively output pixel sum values each obtained by adding up an odd number of pixels distributed consecutively in the specified direction.

These and other objects, advantages and features of the invention will become apparent from the following description thereof taken I conjunction with the accompanying drawings, which illustrate specific embodiments of the invention.

### BRIEF DESCRIPTION OF THE DRAWINGS

In the following description, like parts are designated by like reference numbers throughout the several drawings.

FIG. 1 is a front view of a digital camera;

FIG. 2 is a rear view of the digital camera;

FIG. 3 is a block diagram showing an internal structure of the digital camera;

FIG. 4 is a view showing an example of the arrangement of pixels on a light-receiving surface in a CCD image pick-up element;

FIG. 5 shows a relationship between sampling pulses and an output signal when an individual output mode is set;

FIG. 6 shows a relationship between the sampling pulses and the output signal when the brightness of an object lowers when the individual output mode is set;

FIG. 7 shows a relationship between the sampling pulses and the output signal when a sum output mode is set;

FIG. 8 is a view showing the concept of an output signal from the CCD image pick-up element when the sum output mode is set;

FIG. 9 is a view showing the concept of image data stored in an image memory when the sum output mode is set;

FIG. 10 is a view showing a structure of a reproducing portion; and

FIG. 11 is a view showing the concept of image data generated by the reproducing portion when the sum output mode is set.

### DETAILED DESCRIPTION OF THE PREFERRED EMBODIMENTS

Referring to the drawings, the embodiments of the present invention will be described herein below in detail. In the following description, a digital cameral is shown as an example of an image pick-up apparatus.

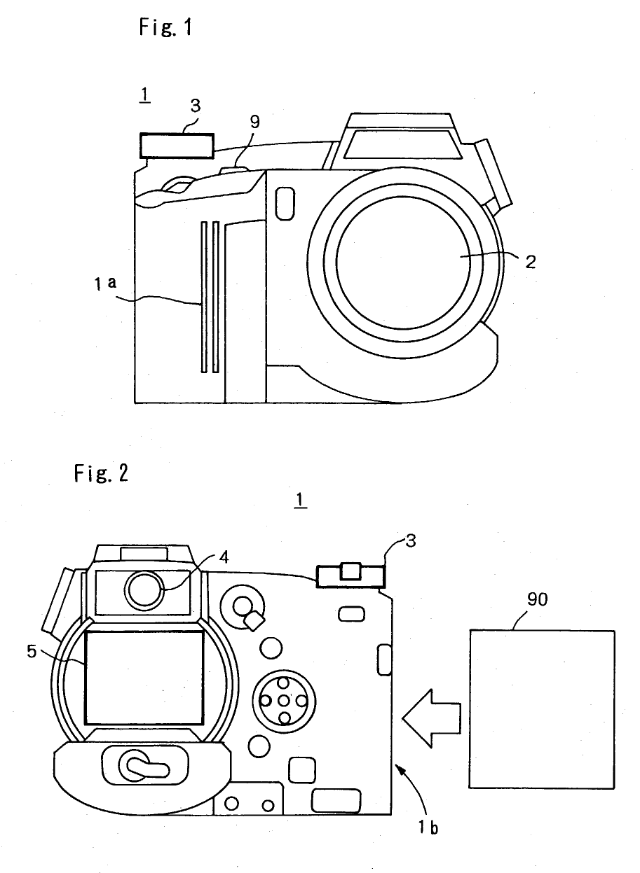

FIGS. 1 and 2 are views each showing an external structure of the digital camera 1.

A taking lens 2 is provided on the front side of the digital camera 1 to form an image by focusing light from an object on a photoelectric conversion element disposed at the back of the taking lens 2.

A shutter start button (hereinafter referred to as the shutter button) 9 is provided on the upper part of a grip portion 1a of the digital camera 1. The shutter button 9 comprises a two-stage push switch capable of distinctly sensing a half-pushed state and a full-pushed state brought about by the user. For example, automatic focusing control is initiated in the half-pushed state and an actual photographing operation for obtaining an image to be recorded is initiated in the full-pushed state.

In the upper part of the digital camera 1, a mode switching dial 3 for switching between “Recording Mode” and “Reproduction Mode” is provided. The recording mode is for photographing an object and generating image data. The reproduction mode is for reproducing and displaying the image data recorded in a memory card 90 on a liquid crystal display element (hereinafter referred to as the LCD) 5 provided on the rear side of the digital camera 1.

On the rear side of the digital camera 1, the LCD 5 for displaying a live view before an actual photographing operation and reproducing and displaying an image that has been photographed and an electronic view finder (hereinafter referred to as EVF) 4 are provided. Each of the LCD 5 and the EVF 4 is adapted to display a color image and function as a color image display device.

An insertion/holding portion 1 for the memory card 90 as a detachable recording medium is provided in the side surface of the digital camera 1. Image data obtained by the actual photographing operation is recorded on the memory card 90 set in the insertion/holding port 1b.

In the foregoing digital camera 1, a live view image which is a real-time image of an object is displayed on the LCD 5 or the EVF 4 in the state before the user performs the full-pushing operation of the shutter button 9 in the photographing mode, i.e., in the taking standby state prior to the initiation of the actual photographing operation. Accordingly, the photoelectric conversion element in the digital camera 1 repeatedly performs photoelectric converting operations even in the taking standby state and image generation for performing the live view display is performed continuously.

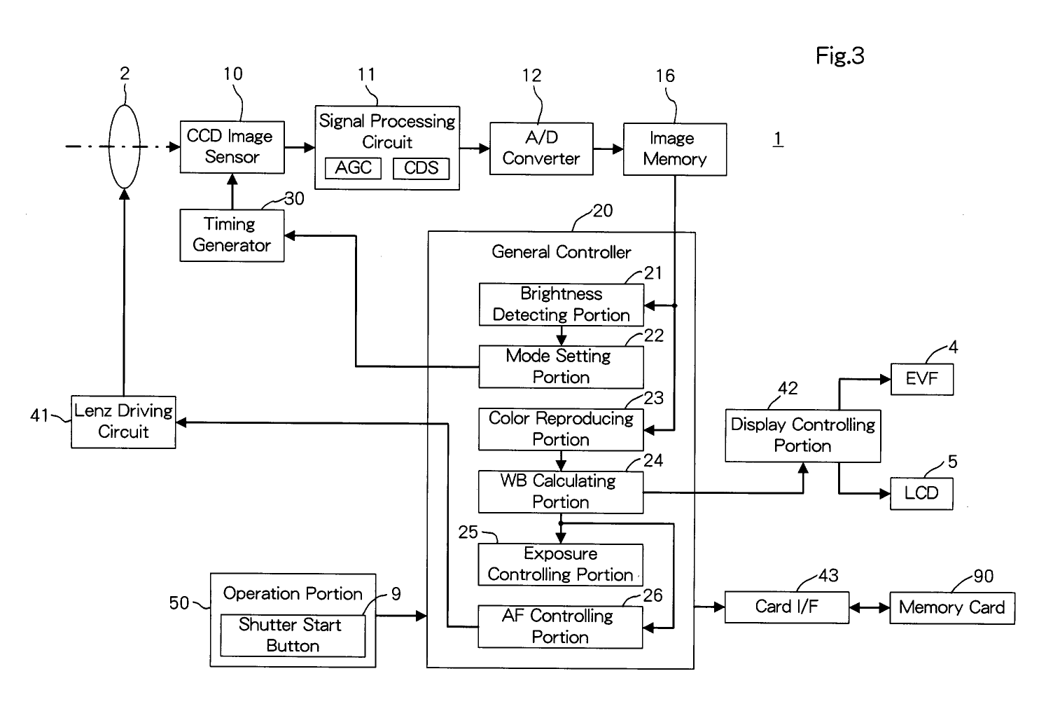

Next, a description will be given the internal structure of the digital camera 1 referring FIG. 3,

Light from the object is incident upon the CCD image pick-up element 10 having a structure in which a plurality of light-receiving elements (corresponding to pixels) are arranged in two dimension. The CCD image pick-up element (referred as CCD hereinafter) 10 functions as a photoelectric conversion element and accumulates pixel signals (pixel values) commensurate with an amount of incident light by performing photoelectric conversion for each of the pixels. The CCD 10 is adapted to successively output the pixel values accumulated on a pixel-by-pixel basis as analog signals in response to sample pulses from a timing generator 30.

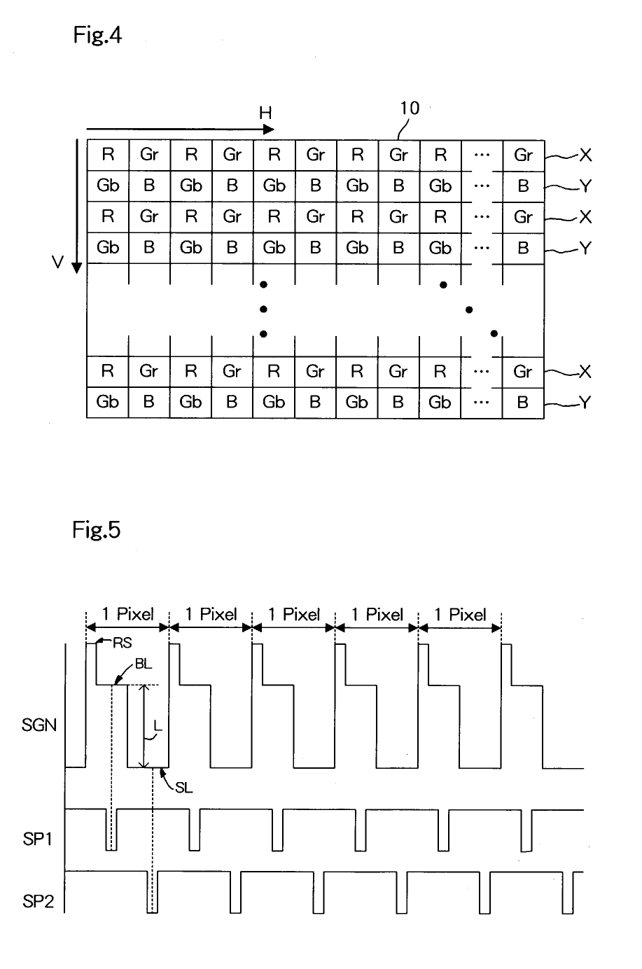

FIG. 4 shows an example of the arrangement of pixels on the light receiving surface of the CCD 10. In FIG. 4, each of Gr and Gb represents a G (green) component but Gr and Gb are shown distinctly since the sensitivities thereof are slightly different from one line to another due to different read timings or the like.

As shown in FIG. 4, each of the pixels composing the CCD 10 is adapted to sense light of any of the three color components R (red), G (green), and B (blue). The CCD has a Bayer arrangement filter so that pixels for different color components are alternately and repeatedly arranged in a horizontal direction H. Specifically, the pixels for sensing the R component and the pixels for sensing the Gr component are alternately and repeatedly arranged in a line X parallel to the horizontal direction H, while the pixels for sensing the Gr component and the pixels for sensing the B component are alternately and repeatedly arranged in a line Y.

When the CCD 10 outputs the pixel values, it successively outputs the pixel values accumulated on a per pixel basis in the horizontal direction H. If attention is focused on, e.g., the line X, the pixel value for the R component is outputted first, then the pixel value for the Gr component is outputted, and subsequently the pixel value for the R component is outputted again. When the pixel values in each of the lines are to be outputted, therefore, the pixel values for the different color components are alternately outputted from the CCD 10.

A signal processing circuit 11 is for performing specified signal processing with respect to an analog signal obtained on a per pixel basis from the CCD 10. The signal processing circuit 11 is composed of an automatic gain control circuit (hereinafter referred to as the AGC circuit) 11a and a correlated double sampling circuit (hereinafter referred to as a CDS circuit) 11b. The AGC circuit 11a is adapted to give gain commensurate with a signal level to the pixel value and the CDS circuit 11b is adapted to remove a noise component contained in the pixel value therefrom.

The pixel value after the specified signal processing is performed in the signal processing circuit 11 is inputted to an A/D converter 12 and converted from an analog signal to a digital signal. The A/D converter 12 has the function of converting the pixel value which is an analog signal to, e.g., a 12-bit digital signal. The pixel value converted to the digital signal is transferred successively to the image memory 13.

The image memory 13 has a storage region for storing the pixel values corresponding to at least one frame. The pixel values converted to digital signals corresponding to one frame are stored in the image memory 13 to form one frame of image data in the image memory 13. The image data generated in the image memory 13 is given to an overall controller 20.

Then, a lens driving circuit 41 drives the taking lens 2 based on an instruction from the overall controller 20 and realizes a focused state of an image of the object formed on the CCD 10. If the shutter button 9 is half-pushed in the photographing mode, the AF controller 26 functions in the overall controller 20 to move stepwise a focusing lens unit included in the taking lens 2 in the direction of the optical axis, specify the position of the lens brought into the focused state based on the contrast or edge of the image obtained at each of the positions of the focusing lens unit, and drive the focusing lens unit to the position of the lens.

A display controller 42 is for outputting an image to be displayed obtained from the overall controller 20 to the EVF 4 or the LCD 5. In the taking standby state, the display controller 42 outputs a live view image obtained from the overall controller 20 to the EVF 4 or the LCD 5. As a result, live view display is performed on the EVF 4 or the LCD 5 in the taking standby state. Since the number of display pixels of each of the EVF 4 and the LCD 5 is smaller than the number of pixels of the CCD 10, the display controller 42 has the function of reducing the size of the image by performing a thin-out process or the like with respect to the pixels when outputting the image to be displayed based on the image data stored in the image memory 13 and thereby converting the image data to image data compliant with the number of display pixels.

A card interface 43 performs a recording/reading operation to/from the memory card 90 inserted into the digital camera 1. Photographed image data obtained by the actual photographing operation is recorded by the overall controller 20 in the memory card 90 via the card interface 43.

An operating portion 50 includes operating members such as the shutter button 9 and the like so as to give instructions to the digital camera 1 by the user.

The function of the overall controller 20 is implemented by a CPU provided in the digital camera 1 which performs a specified program and has the function of integrally controlling the individual components of the digital camera 1.

As shown in FIG. 3, the overall controller 20 also functions as a brightness determining portion 21 for determining the brightness of an object, a mode setting portion 22 for switching the pixel-value output mode of the CCD 10, the reproducing portion 23 for reproducing color information on a pixel-by-pixel basis, a WB arithmetic operation portion 24 for adjusting the white balance (hereinafter referred to as WB) of an image, an exposure controller 25 for controlling exposure in preparation for the actual photographing operation, and an AF controller 26 for performing automatic focusing (AF) control.

The brightness determining portion 21 is adapted to obtain image data stored in the image memory 13 and evaluate the overall brightness level of the image. For example, the brightness determining portion 21 obtains a mean brightness value of the entire image and examines whether or not the mean brightness value is smaller than a specified value TH1. If the mean brightness value is smaller than the specified value TH1, the brightness determining portion 21 gives, to the mode setting portion 22, an instruction to switch the pixel-value output mode of the CCD 10 to a sum output mode.

When the sum output mode has already been set by the mode setting portion 22, the brightness determining portion 21 gives, to the mode setting portion 22, an instruction to switch the pixel-value output mode of the CCD 10 to an individual output mode if the mean brightness value of the image obtained from the image memory 13 becomes a specified value TH2 or more.

The mode setting portion 22 is for switching the pixel-value output mode of the CCD 10 to either the individual output mode or the sum output mode in response to an instruction to switch from the brightness determining portion 21. The mode setting portion 22 controls the timing generator 30 based on the pixel-value output mode of the CCD 10 which is set in accordance with the brightness level of the object.

The individual output mode is for outputting individual pixel values from the CCD 10 on a pixel-by-pixel basis. The individual output mode is adopted when the brightness of the object is relatively high and each of the pixels accumulates a value on a sufficient signal level.

By contrast, the sum output mode is for outputting output values from the CCD 10 as sum values each obtained by adding up a given odd number of pixel values distributed consecutively in the horizontal direction H. The sum output mode is adopted when the brightness of the object is relatively low and each of the pixels does not accumulate a pixel value on a sufficient signal level. In the sum output mode, pixel values which are accumulated in respective groups of pixels formed by dividing pixels distributed consecutively in a specified direction in the CCD 10 into the groups each consisting of a given odd number, of pixels are added up on a per group basis to provide pixel sum values, which are outputted from the CCD 10.

When the individual output mode is set, the timing generator 30 gives sampling pulses to the CCD 10 such that the pixel values accumulated in the individual pixels are outputted individually.

FIG. 5 shows a relationship between the sampling pulses SP1 and SP2 from the timing generator 30 and an output signal SGN outputted from the CCD 10 when the individual output mode is set.

As shown in FIG. 5, when the individual output mode is set, the sampling pulse SP1 for setting a black level as a reference for each of the pixels and the sampling pulse SP2 for setting a signal level for each of the pixels are given from the timing generator 30 to the CCD 10. On receiving the sampling pulses SP1 and SP2 which are given for each of the pixels from the timing generator 30, the CCD 10 generates a reset signal RS for a specified period for each of the pixels, outputs a black level signal BL, and then outputs a signal SL indicative of the signal level. Consequently, the pixel value outputted from the CCD 10 when the individual output mode is set is expressed as a difference L between the black level BL and the signal level SL.

As shown in FIG. 5, the sampling pulses SP1 and SP2 are repeatedly given by the timing generator 30 to the CCD 10 in cycles each corresponding to one pixel so that the pixel values accumulated on a pixel-by-pixel basis in the horizontal direction H are outputted from the CCD 10. However, since the CCD 10 has a structure in which the pixels for sensing the different color components are arranged alternately in the horizontal direction H, as shown in FIG. 4, it follows that the output signals SGN from the CCD 10 alternately indicate the pixel values L sensed for the different color components.

When the brightness of the object lowers in the individual output mode shown in FIG. 5, the difference L between the black level BL and the signal level SL is reduced.

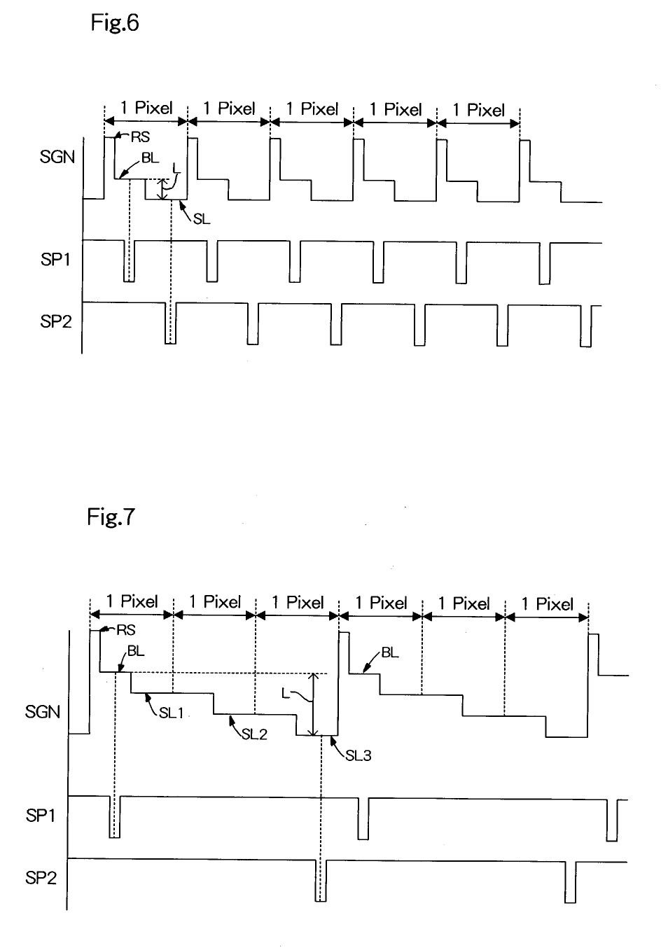

FIG. 6 shows a relationship between the sampling pulses SP1 and SP2 and the output signal SGN from the CCD 10 when the brightness of the object lowers in the individual output mode. As shown in FIG. 6, if the difference L between the black level BL and the signal level SL decreases with the lowering of the brightness of the object, a pixel value on a sufficient signal level cannot be obtained. Since the black level signal BL of the output signal SGN contains a noise component in fixed proportions, if high gain is given to the pixel value in the AGC circuit 11a in the subsequent stage when the difference L between the black level BL and the signal level SL decreases, even the noise component is amplified significantly.

To prevent this, the present embodiment causes the overall controller 20 to change the operating mode of the timing generator 30 when the brightness of the object is reduced to a level lower than a specified value TH1 such that each odd number of pixel values distributed consecutively in the horizontal direction H, which is the direction in which the pixel values are outputted, are added up and outputted from the CCD 10.

When the sum output mode is set, the timing generator 30 gives the sampling pulses to the CCD 10 such that pixel values accumulated in each odd number of pixels are added up and outputted.

FIG. 7 is a view showing a relationship between the sampling pulses SP1 and SP2 from the timing generator 30 and the output signal SGN from the CCD 10 when the sum output mode is set. In the case shown in FIG. 7, the number of pixels to be added up is set to 3 by way of example.

As shown in FIG. 7, when the sum output mode is set, the timing generator 30 gives the sampling pulse SP1 for setting a black level as a reference for each three pixels and the sampling pulse SP2 for setting a signal level for each three pixels to the CCD 10.

On receiving the sampling pulses SP1 and SP2 which are given for each three pixels by the timing generator 30, the CCD 10 generates a reset signal RS for a specified period for each three pixels and then outputs the black level signal BL.

After the black level signal BL is outputted, a signal SL1 indicative of the signal level of the first pixel is outputted. At this time, the CCD 10 does not receive the sampling pulse SP2, which is different from the case where the individual output mode is set, so that the CCD 10 sets the black level of the second pixel to the signal level of the first pixel without resetting the output level and outputs a signal SL2 indicative of the signal level of the second pixel. Then, the CCD 10 sets the black level of the third pixel to the signal level of the second signal without resetting the output level and outputs a signal SL3 indicative of the signal level of the third pixel. At this time, the sampling pulse SP2 is given to the CCD 10. Consequently, the pixel value (pixel sum value) outputted from the CCD 10 when the sum output mode is set is represented as the difference L between the black level BL and the summed signal level from SL1 to SL3. This enables the CCD 10 to output a pixel sum value on a sufficient signal level even if each of the pixels does not accumulate the pixel value on a sufficient signal level.

As shown in FIG. 7, the sampling pulses SP1 and SP2 are repeatedly given by the timing generator 30 to the CCD 10 in a cycle corresponding to three pixels so that the pixel sum value obtained by adding up the respective pixel values accumulated in three pixels distributed consecutively in the horizontal direction H is outputted from the CCD 10.

Thus, even if a signal level accumulated in each of the pixels is low, a large signal component can be extracted without amplifying the low signal level when the sum output mode is set. This obviates the necessity to increase gain set in the AGC circuit 11a so that an effective signal component is obtainable without increasing the noise component.

When the sum output mode is set, the number of data sets (the number of pixels) in the horizontal direction H is reduced to ⅓ since only one pixel sum value is obtainable from three pixels distributed consecutively in the horizontal direction H.

Since the CCD 10 has the structure in which the pixels for sensing different color components are alternately arranged in the horizontal direction H, as shown in FIG. 4, pixel sum values each obtained by adding up the pixel values for the different color components are outputted from the CCD 10 when the sum output mode is set.

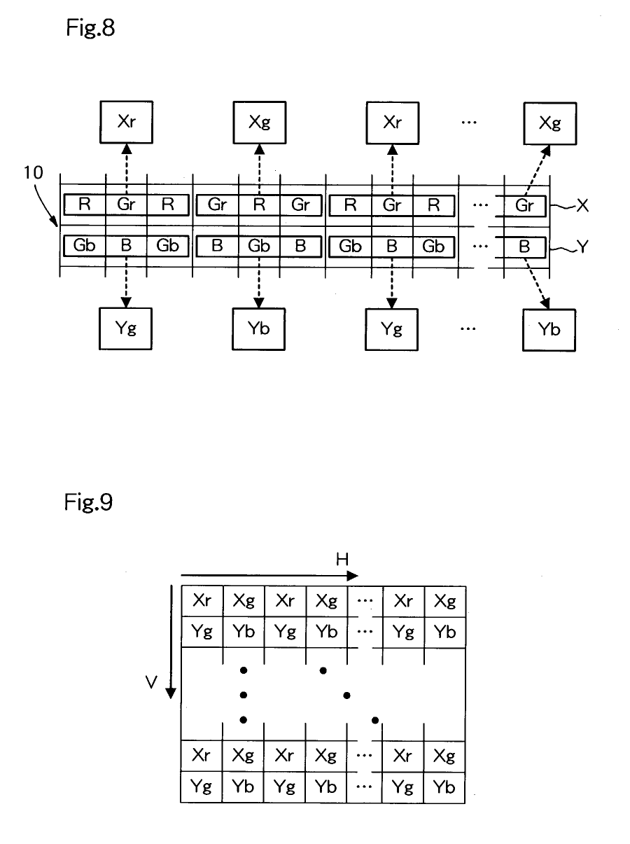

FIG. 8 is a view showing the concept of an output signal from the CCD 10 when the sum output mode is set and the case where the number of pixels to be added up is 3. If attention is focused on, e.g., the line X in which pixels for the R component and pixels for the Gr components are alternately arranged, pixel sum values Xr and Xg each obtained from three pixels are alternately outputted from the line X. If attention is focused on, e.g., the line Y in which pixels for the Gb component and pixels for the B components are alternately arranged, pixel sum values Yb and Yg each obtained from three pixels are alternately outputted from the line Y.

Since the present embodiment adds up each odd number of pixels arranged in the horizontal direction H, the number of the pixels for the R component contained in the group of pixels added up for the pixel sum value Xr is larger by one than the number of the pixels for the Gr component contained therein and the number of the pixels for the Gr component contained in the group of pixels added up for the pixel sum value Xg is larger by one than the number of the pixels for the R component contained therein. Likewise, the number of the pixels for the Gb component contained in the group of pixels added up for the pixel sum value Yg is larger by one than the number of the pixels for the B component contained therein and the number of the B contained in the group of pixels added up for the pixel sum value Yb is larger by one than the number of the pixels for the Gb component contained therein.

By thus setting the number of pixels added up in the horizontal direction H to an odd number, the number of pixels for a specified color component contained in each of the pixel sum values Xr, Xg, Yg, and Yb is larger by one than the number of pixels for another color component contained therein so that color information is not completely lost. This allows the reproducing portion 23, which will be described later, to reproduce, from the pixel sum values Xr, Xg, Yg, and Yb each containing a larger number of pixels for a specified color component, color information on the groups of pixels that have been added up for the respective pixel sum values.

When the sum output mode is set, the pixel sum values Xr, Xg, Yg, and Yb each obtained by adding up an odd number of pixel values distributed consecutively in the horizontal direction H are thus outputted as output signals from the CCD 10 and the outputted pixel sum values Xr, Xg, Yg, and Yb are given to the signal processing circuit 11.

In either of the individual output mode or the sum output mode, the pixel values or the pixel sum values outputted from the CCD 10 are given to the A/D converter 12 through the signal processing circuit 11 so that image data converted to digital signals is stored in the image memory 13.

When the individual output mode is set, if p pixel values in the horizontal direction H and q lines of pixel values in the vertical direction V are outputted individually from the CCD 10 (where p and q are arbitrary integers), image data composed of p×q pixels is stored in the image memory 13.

By contrast, if it is assumed that (2n+1) pixel values distributed consecutively in the horizontal direction H are added up (where n is an arbitrary natural number) when the sum output mode is set, image data composed of {p/(2n+1)}×q is stored in the image memory 13.

FIG. 9 is a view showing the concept of image data stored in the image memory 13 when the sum output mode is set. As shown in FIG. 9, when the sum output mode is set, the pixel sum value obtained from a group consisting of an odd number of pixels in the horizontal direction H which have been added up is represented as one pixel.

Accordingly, the number of pixels in the horizontal direction H composing image data is reduced to 1/(2n+1) when the sum output mode is set. However, this does not particularly present a problem since the object of using image data in the taking standby state is not to obtaining image data to be recorded or stored, but to properly performing live view display on the EVF 4 or LCD 5 having a small number of display pixels, a WB arithmetic operation, an exposure arithmetic operation, AF control, and the like.

When the sum output mode is set, the reproducing portion 23 functions in the overall controller 20 and the image data stored in the image memory 13 is inputted to the reproducing portion 23. The reproducing portion 23 is for reproducing color information on R, G, and B from the pixel sum values Xr, Xg, Yg, and Yb if the group of pixels added up for each of the pixel sum values is assumed to be one pixel.

A description will be given first to the principle of color reproduction. It is assumed that the number of pixels to be added up, which is set to an odd number, in the sum output mode is (2n+1) where n is an arbitrary natural number.

The pixel sum value Xr containing a larger number of pixels for the R component is obtained first from the line X in which the pixels for the R component and the pixels for the Gr components are arranged alternately in the horizontal direction H in the CCD 10. The pixel sum value Xr is represented by:

Xr=(n+1)*R+n*Gr (1)

The pixel sum value Xg containing a larger number of pixels for the Gr component is obtained second from the same line X. The pixel sum value Xg is represented by:

Xg=n*R+(n+1)*Gr (2)

On the other hand, the pixel sum value Yg containing a larger number of pixels for the Gb component is obtained first from the line Y in which the pixels for the Gb component and the pixels for the B components are arranged alternately in the horizontal direction H in the CCD 10. The pixel sum value Yg is represented by:

Yg=(n+1)*Gb+n*B (3)

The pixel sum value Yb containing a larger number of pixels for the B component is obtained second from the same line Y. The pixel sum value Yb is represented by:

Yb=n*Gb+(n+1)*B (4)

From the pixel sum values Xr and Xg, a difference value ΔX between the pixels for the Gr component and the pixels for the R component is obtained, which is given by:

ΔX=Xg−Xr=Gr−R (5)

From the pixel sum values Yg and Yb, a difference value ΔY between the pixels for the Gb component and the pixels for the B component is obtained, which is given by:

ΔY=Yg−Yb=Gb−B (6)

Then, product values n·ΔX and n·ΔY obtained by multiplying the difference values ΔX and ΔY by n which is a value commensurate with the odd number of pixels that have been added up are obtained. The color information on R, G, and B can be reproduced by adding or subtracting the product values n·ΔX and n·ΔY to or from each of the pixel sum values Xr, Xg, Yg, and Yb.

Specifically, color information R′ on the group of pixels from which the pixel sum value Xr has been obtained is given by:

R′=Xr−n*ΔX=(2n+1)*R (7)

Color information Gr′ on the group of pixels from which the pixel sum value Xg has been obtained is given by:

Gr′=Xg+n*ΔX=(2n+1)*Gr (8)

Color information Gb′ on the group of pixels from which the pixel sum value Yg has been obtained is given by:

Gb′=Yg+n*ΔY=(2n+1)*Gb (9)

Color information B′ on the group of pixels from which the pixel sum value Yb has been obtained is given by:

B′=Yb−n*ΔY=(2n+1)*B (10)

Thus, the color information on R, G, B corresponding to the individual groups of pixels that have been added up can be reproduced from the pixel sum values Xr, Xg, Yg, and Yb by the reproducing portion 23 in which the foregoing arithmetic operations are performed.

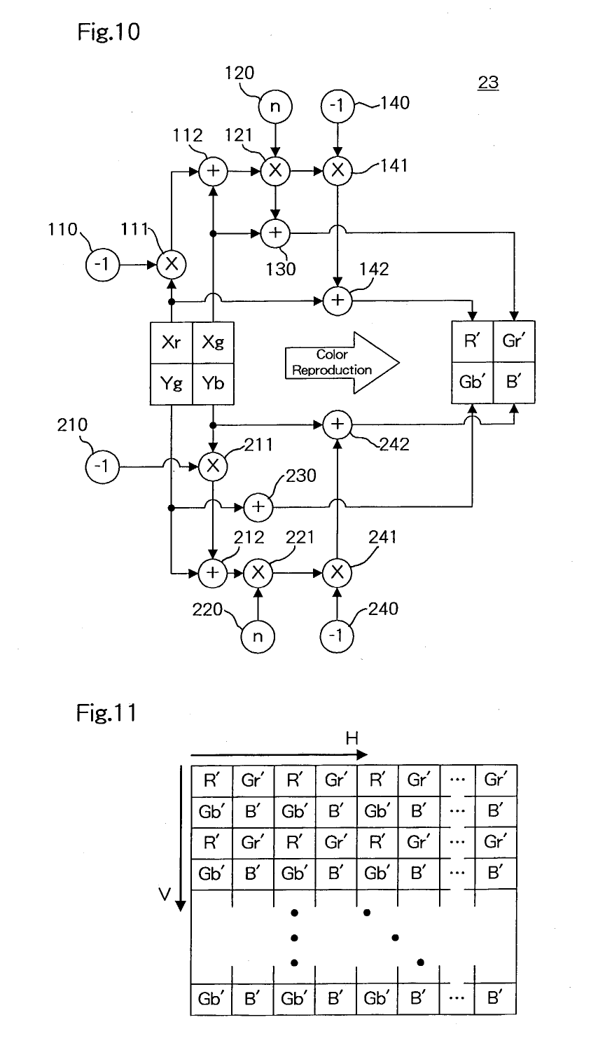

FIG. 10 is a view showing a structure of the reproducing portion 23. As shown in FIG. 10, the reproducing portion 23 obtains the pixel sum value Xr, Xg, Yg, and Yb contained in the 2×2 regions serving as regions to be processed from the image data stored in the image memory 13 and generates the color information R′, Gr′, Gb′, and B′ contained in the 2×2 regions. By scanning the regions to be processed in the entire region of the image data, the reproduction of color information on the entire color data is performed.

In a multiplier 111, the pixel sum value Xr is multiplied by −1, which is a coefficient given by a coefficient portion 110. In an adder 112, the pixel sum value Xg is added and the arithmetic operation shown in the foregoing numerical expression (5) is performed. Consequently, the multiplier 111, the coefficient portion 110, and the adder 112 function as a difference detector for determining the difference value ΔX between the pixel sum value Xg and the pixel sum value Xr.

An output from the adder 112 is given to a multiplier 121 where the coefficient n given by the coefficient portion 120 is multiplied. Consequently, the coefficient portion 120 and the multiplier 121 function as a multiplication part for multiplying the difference value ΔX by the value n corresponding to the odd number and thereby determining the product value n·ΔX.

An output from the multiplier 121 is given to an adder 130 and to a multiplier 141. The adder 130 has the function of adding the product value n·ΔX to the pixel sum value Xg. From an output from the adder 130, the color information Gr′ corresponding to the group of pixels from which the pixel sum value Xg has been obtained is obtainable. In the multiplier 141, the coefficient −1 given by a coefficient portion 140 is multiplied and an output value from the multiplier 141 is given to an adder 142. The adder 142 has the function of adding the product value (−n·ΔX) to the pixel sum value Xg. From an output from the adder 142, the color information R′ corresponding to the group of pixels from which the pixel sum value Xr has been obtained is obtainable. Thus, the adder 130, the coefficient portion 140, the multiplier 141, and the adder 142 function as an addition-subtraction part for adding or subtracting the product value n·ΔX to or from each of the pixel sum values Xr and Xg. As a result, the color information R′ and Gr′ is obtained from the pixel sum values Xr and Xg obtained from the line X.

Subsequently, in a multiplier 211, the pixel sum value Yb is multiplied by −1, which is a coefficient given by a coefficient portion 210. In an adder 212, the pixel sum value Yg is added and the arithmetic operation shown in the foregoing numerical expression (6) is performed. Consequently, the multiplier 211, the coefficient portion 210, and the adder 212 function as a difference detector for determining the difference value ΔY between the pixel sum value Yg and the pixel sum value Yb.

An output from the adder 212 is given to a multiplier 221 where the coefficient n given by the coefficient portion 220 is multiplied. Consequently, the coefficient portion 220 and the multiplier 221 function as a multiplication part for multiplying the difference value ΔY by the value n corresponding to the odd number and thereby determining the product value n·ΔY.

An output from the multiplier 221 is given to an adder 230 and to a multiplier 241. The adder 230 has the function of adding the product value n·ΔY to the pixel sum value Yg. From an output from the adder 230, the color information Gb′ corresponding to the group of pixels from which the pixel sum value Yg has been obtained is obtainable. In a multiplier 241, the coefficient −1 given by a coefficient portion 240 is multiplied and an output value from the multiplier 241 is given to an adder 242. The adder 242 has the function of adding the product value (−n·ΔY) to the pixel sum value Yb. From an output from the adder 242, the color information B′ corresponding to the group of pixels from which the pixel sum value Yb has been obtained is obtainable. Thus, the adder 230, the coefficient portion 240, the multiplier 241, and the adder 242 function as an addition-subtraction part for adding or subtracting the product value n·ΔY to or from each of the pixel sum values Yg and Yb. As a result, the color information Gb′ and B′ is obtained from the pixel sum values Yg and Yb obtained from the line Y.

The foregoing structure allows the reproducing portion 23 to obtain, from the image data stored in the image memory 13, the pixel sum values Xr, Xg, Yg, and Yb contained in the 2×2 regions serving as the regions to be processed and generate the color information R′, Gr′, Gb′, and B′ contained in the 2×2 regions. By scanning the regions to be processed in the entire region of the image data, the reproduction of the color information on the entire image data can be performed.

The reproducing portion 23 performs the foregoing arithmetic operations for color reproduction and thereby generates image data with the reproduced color information from the image data stored in the image memory 13. FIG. 11 shows the concept of the image data generated by the reproducing portion 23 when the sum output mode is set. As shown in FIG. 11, the image data with the reproduced color information can be generated from the image data shown in FIG. 9 by the reproducing portion 23 performing the foregoing arithmetic operations. The number of pixels composing the image data shown in FIG. 11 is the same as the number of pixels composing the image data shown in FIG. 9.

Although FIG. 10 shows the case where the reproducing portion 23 is implemented by a hardware structure, it is not limited thereto. The reproducing portion 23 may also be implemented by executing the foregoing process of arithmetic operations by using software.

The image data with the color information reproduced in the reproducing portion 23 is given to the WB arithmetic operation portion 24.

Since the pixel values obtained as a result of individually sensing the R, G, and B color components are outputted individually in the individual output mode, the color information need not be reproduced. Therefore, the reproducing portion 23 does not function in the overall controller 20 in the individual output mode and the image data stored in the image memory 13 is given directly to the WB operation portion 24.

The WB operation portion 24 obtains gain values G(R) and G(B) for adjusting white balance from the image data with the reproduced color information which is obtained from the reproducing portion 23 and generates, from the gain values G(R) and G(B), color information R″ on the R component and color information B″ on the B component for each of which white balance has been adjusted.

Specifically, if the number of pixels in the horizontal direction H and the number of pixels in the vertical direction V in the image data with the reproduced color information are assumed to be h and v, respectively, the gain value G(R) for adjusting the R component is given by:

$$G ( R ) = ( \frac{{\sum }_{v} {\sum }_{h} {Gr}^{′} + {\sum }_{v} {\sum }_{h} {Gb}^{′}}{2} ) / {\sum }_{v} {\sum }_{h} {R}^{′} \qquad ( 11 )$$

and the gain value G(B) for adjusting the B component is given by:

$$G ( B ) = ( \frac{{\sum }_{v} {\sum }_{h} {Gr}^{′} + {\sum }_{v} {\sum }_{h} {Gb}^{′}}{2} ) / {\sum }_{v} {\sum }_{h} {B}^{′} \qquad ( 12 )$$

By performing an arithmetic operation represented by:

R″=G(R)*R′ (13)

by using the gain value G(R), the color information R″ on the R component for which white balance has been adjusted is obtainable.

By performing an arithmetic operation represented by:

B″=G(B)*B′ (14)

by using the gain value G(B), the color information B″ on the B component for which white balance has been adjusted is obtainable.

By performing white balance adjustment as described above in the WB arithmetic operation portion 24, a proper color image with a natural appearance can be displayed when live view display is performed on the EVF 4 or the LCD 5. When the individual output mode is set, the WB arithmetic operation portion 24 generates image data for which white balance has been adjusted by performing the same arithmetic operation as described above with respect to the image data obtained from the image memory 13.

The WB arithmetic operation portion 24 then outputs the image data for which white balance has been adjusted to the display controller 42, the exposure controller 25, and the AF controller 26.

On receiving the image data for which white balance has been adjusted from the WB arithmetic operation portion 24, the display controller 42 generates an image to be displayed that has been adjusted to the display size of the EVF 4 or the LCD 5 and performs live view display on the EVF 4 or the LCD 5. Even if the pixel sum values each obtained by adding up the pixel values are outputted from the CCD 10 in the sum output mode, the display controller 42 receives image data including proper color information from the WB arithmetic operation portion 24, a live view image can be color displayed.

The exposure controller 25 obtains an evaluation value Ex for exposure control from the image data for which white balance has been adjusted obtainable from the WB arithmetic operation portion 24. The evaluation value Ex for exposure control is represented by, e.g., the brightness of the object and obtained by performing an arithmetic operation represented by:

$$Ex = \frac{1}{h * v} ( \frac{76}{256} {\sum }_{v} {\sum }_{h} {R}^{″} + \frac{150}{256} {\sum }_{v} {\sum }_{h} {G}^{′} + \frac{30}{256} {\sum }_{v} {\sum }_{h} {B}^{″} ) \qquad ( 15 )$$

wherein G′ represents the color information Gr′ and Gb′ described above.

The exposure controller 25 determines the shutter speed (exposure time) of the CCD 10, the aperture value of the taking lens 2, and the like such that the evaluation value Ex obtained by performing the arithmetic operation represented by the foregoing numerical expression (15), i.e., the brightness of the object reaches a specified level, sets the values to the individual components, and thereby performs automatic exposure control. Even if the pixel sum values each obtained by adding up the pixel values are outputted from the CCD 10 in the sum output mode, the exposure controller 25 receives image data including proper color information from the WB arithmetic operation portion 24 so that normal and proper exposure control is performed.

The AF controller 26 evaluates, when the shutter button 9 is half-pushed, the focused state of an image based on the image data obtained from the WB arithmetic operation portion 24, drives the focusing lens unit in the taking lens 2, and thereby performs automatic focus control. Even if the pixel sum values each obtained by adding up the pixel values are outputted from the CCD 10 in the sum output mode, the AF controller 26 receives image data including proper color information from the WB arithmetic operation portion 24 so that normal and proper AF control is performed.

When the user performs the full-pushing operation with respect to the shutter button 9 to give an instruction to perform actual photographing, the individual output mode is set in the CCD 10 so that the pixel values are outputted individually on a pixel-by-pixel basis therefrom. In the overall controller 20, data on the photographed image to be recorded is generated and recorded in the memory card 90.

As described above, when the brightness of the object lowers, the sum output mode is set in the digital camera 1 according to the present embodiment so that the pixel sum values each obtained by adding up the pixel values of the pixels distributed consecutively in the horizontal direction H are outputted from the CCD 10. Consequently, the pixel sum values each containing the signal component in a large quantity is obtainable if an object with a low brightness is to be photographed without increasing the gain used in the AGC circuit 11a to a level at which image quality degradation occurs.

In the digital camera 1, the number of pixels to be added to obtain the pixel sum value has been set to an odd number so that the pixel sum value containing a larger number of pixels for a specified color component than pixels for another color component is outputted from the CCD 10. This indicates that color information is not completely lost from the pixel sum value obtained by adding up an odd number of pixels when the sum output mode is set so that the color information is reproducible from the pixel sum value.

Since the digital camera 1 is capable of providing an image with the reduced noise component without losing color information even in dark environments, a live view image can be color displayed on the EVF 4 or the LCD 5, while white balance adjustment, exposure control, and AF control can be performed with high accuracy.

The digital camera 1 is also constituted to cause the CCD 10 to individually output the pixel values or output the pixel sum values each obtained by adding up an odd number of pixel values by merely changing the sampling pulses SP1 and SP2 given by the timing generator 30 to the CCD 10. In other words, the digital camera 1 is constituted to cause the CCD 10 to output the pixel sum values each obtained by adding up an odd number of pixels by merely changing a control method for the CCD 10. This obviates the necessity to provide an extra adder or the like for adding up an odd number of pixel values in the stage subsequent to the CCD 10 and thereby easily implements a structure for providing the pixel sum values at low cost.

By constituting the digital camera 1 described above to add up the pixel values on the stage of analog signals, a quantization error such as bit data loss can be eliminated and the pixel sum value can be obtained efficiently. However, it is also possible to add an odd number of pixel values to a digitized value.

Although the description has been given thus far to the embodiment, the present invention is not limited to the foregoing description.

For example, the arrangement of pixels in the CCD 10 is not limited to the Bayer arrangement provided that the pixels for the first color component and the pixels for the second component are arranged alternately in the specified direction and that the pixel values are outputted successively in the specified direction.

Since the essence of the foregoing technology is applicable to the case where an object with a low brightness is photographed and a color image with a reduced noise component is generated, the range of the application thereof is not limited to digital cameras.

Since a larger signal component is obtainable as the number of pixels to be added up, which is set to an odd number, is increased, the number of pixels to be added up may also be increased stepwise such that the number of pixels to be added up is set to a larger odd number as the brightness of the object lowers.

The above structure causes, when the pixel values are outputted from the photoelectric conversion element, the photoelectric conversion element to successively output the pixel sum values each obtained by adding up an odd number of pixel values distributed consecutively in the specified direction. Accordingly, a large signal component is obtainable without amplifying the noise component. Since the pixel sum values can be obtained without completely impairing the color information, the color information on the image can be reproduced.

In accordance with the above structure, the respective color component values of the first group of pixels containing the first color component in a larger quantity and the second groups of pixels containing the second color component in a larger quantity are determined based on the first pixel sum value obtained from the first group of pixels and on the second pixel sum value obtained from the second group of pixels. Accordingly, color information with a reduced noise component is obtainable.

Since the above structure allows white balance adjustment based on the color component values obtained in the reproduction part, white balance can be adjusted accurately.

Since the above structure allows exposure control based on the color component values obtained in the color reproduction part when a photographing operation using the photoelectric conversion element is performed, accurate exposure control can be performed.

Since the above structure allows color display of an image based on the color component values obtained in the reproduction part, a color image can be displayed properly.

The above structure provides color information with a reduced noise component.

The above structure provides a large signal component if the brightness of the object is low without amplifying the noise component. Since the pixel sum values are obtainable without completely impairing the color information, the color information on the image can be reproduced.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. An image pick-up apparatus comprising:
a photoelectric conversion element having pixels for a first color component and pixels for a second color component which are arranged alternately in a specified direction, the photoelectric conversion element successively outputting respective values of the pixels in the specified direction; and
a controller for causing, when the respective values of the pixels are outputted from the photoelectric conversion element, the photoelectric conversion element to successively output pixel sum values each obtained by adding up an odd number of pixels distributed consecutively in the specified direction.

2. An image pick-up apparatus according to claim 1 further comprising:
a reproduction part for determining, based on a first pixel sum value of the pixel sum values which is obtained from a first group of pixels containing the first color component in a larger quantity and on a second pixel sum value of the pixel sum values which is obtained from a second group of pixels containing the second color component in a larger quantity, respective color component values of the first and second groups of pixels.

3. An image pick-up apparatus according to claim 2,
wherein white balance adjustment is performed based on the color component values obtained in the reproduction part.

4. An image pick-up apparatus according to claim 2,
wherein, based on the color component values obtained in the reproduction part, exposure control is performed when a photographing operation using the photoelectric conversion element is performed.

5. An image pick-up apparatus according to claim 2 further comprising:
a color image display device for displaying an image obtained by the photoelectric conversion element, and
wherein the color image display device performs color display of the image based on the color component values obtained in the reproducing part.

6. An image pick-up apparatus according to claim 2,
wherein the reproduction part comprises a difference detector for determining a difference between the first pixel sum value and the second pixel sum value, a multiplying part for multiplying the difference by a value commensurate with the odd number to provide a product value, and an adding/subtracting part for adding or subtracting the product value to or from each of the first and second pixel sum values, wherein the color component values of the first and second group of pixels are determined from an output of the adding/subtracting part.

7. An image pick-up apparatus according to claim 1,
wherein the controller determines a brightness of the object based on the pixel values obtained from the photoelectric conversion element and, if the brightness is lower than a specified value, the odd number of pixel values are added up.

8. An image pick-up apparatus according to claim 7 further comprising:
a reproduction part for determining, based on a first pixel sum value of the pixel sum values outputted successively which is obtained from a first group of pixels containing the first color component in a larger quantity and on a second pixel sum value of the pixel sum values which is obtained from a second group of pixels containing the second color component in a larger quantity, respective color component values of the first and second groups of pixels.

9. An image pick-up apparatus according to claim 8,
wherein white balance adjustment is performed based on the color component values obtained in the reproduction part.

10. An image pick-up apparatus according to claim 8,
wherein, based on the color component values obtained in the reproduction part, exposure control is performed when a photographing operation using the photoelectric conversion element is performed.

11. An image pick-up apparatus according to claim 8 further comprising:
a color image display device for displaying an image obtained by the photoelectric conversion element, and
wherein the color image display device performs color display of the image based on the color component values obtained in the reproducing part.

12. An image pick-up apparatus according to claim 8,
wherein the reproduction part comprises a difference detector for determining a difference between the first pixel sum value and the second pixel sum value, a multiplying part for multiplying the difference by a value commensurate with the odd number to provide a product value, and an adding/subtracting part for adding or subtracting the product value to or from each of the first and second pixel sum values, wherein the color component values of the first and second group of pixels are determined from an output of the adding/subtracting part.

13. An image pick-up apparatus according to claim 1, wherein the image pick-up apparatus is a digital camera.

14. An image pick-up apparatus according to claim 2, wherein the image pick-up apparatus is a digital camera.
